(19) United States
(12) Patent Application Publication
(10) Pub. No.: US 2026/0132023 A1
(43) Pub. Date: May 14, 2026

(54) SYSTEM AND METHOD OF CONTINUOUS LOW CARBON HYDROGEN PRODUCTION USING A THERMAL BATTERY INTEGRATED WITH INTERMITTENT RENEWABLE ENERGY

(71) Applicant: Black & Veatch Corporation, Overland Park, KS (US)

(72) Inventors: Justin Cody Distler, Overland Park, KS (US); Andrew Doerflinger, Overland Park, KS (US)

(21) Appl. No.: 19/388,362

(22) Filed: Nov. 13, 2025

Related U.S. Application Data
(60) Provisional application No. 63/720,647, filed on Nov. 14, 2024.

(51) Int. Cl. C01B 3/24; C09C 1/48; F28D 20/00

(52) U.S. Cl. CPC C01B 3/24; C09C 1/487; F28D 20/0034; F28D 20/0056; C01B 2203/0272; C01B 2203/0833; C01B 2203/0872; C01B 2203/1235

(57) ABSTRACT

A system for producing hydrogen gas from a hydrocarbon feed, the system comprising an intermittent energy source, a thermal battery, and a pyrolysis system. The intermittent energy source outputs electrical energy. The thermal battery is in electrical communication with the intermittent energy source, receives the electrical energy, and outputs a heated fluid thermal storage medium. The pyrolysis system is in flow communication with the thermal battery, receives the hydrocarbon feed, receives the heated fluid thermal storage medium, heats the hydrocarbon feed, pyrolyzes the heated hydrocarbon feed to produce heated pyrolysis products, cools the heated pyrolysis products to produce cooled pyrolysis products, separates carbon black from the cooled pyrolysis products, separates hydrogen gas from a remainder of the cooled pyrolysis products, and outputs the hydrogen gas.

### CROSS-REFERENCE TO RELATED APPLICATIONS

The current patent application is a non-provisional utility patent application which claims priority benefit, with regard to all common subject matter, of earlier-filed U.S. Provisional Application Ser. No. 63/720,647; titled “SYSTEM AND METHOD OF METHANE PYROLYSIS INCLUDING A THERMAL BATTERY”; and filed November 14, 2024. The Provisional Application is hereby incorporated by reference, in its entirety, into the current patent application.

### FIELD OF THE INVENTION

Embodiments of the current invention relate to systems and methods for producing hydrogen gas using a thermal battery that is integrated with an intermittent renewable energy source.

### BACKGROUND OF THE INVENTION

Hydrogen technology uses molecular hydrogen to decarbonize hard to abate sectors where electrification is difficult. Today, many companies are developing innovative solutions to produce low-carbon or carbon-free hydrogen molecules that can be used for decarbonizing these sectors. Traditional means of hydrogen production using steam methane reforming (SMR) results in high carbon intensity (typically greater than 10 kgCO₂/kgH₂). Hydrogen production via electrolysis is considered “green” (or carbon free) if the electricity used comes from renewable energy sources. However, renewable energy sources are intermittent. High electricity demand (50+ kWh₍ₑ₎/kgH₂) makes such green hydrogen production projects difficult and costly.

Methane pyrolysis is a newer concept being developed which generally has a much lower carbon intensity than SMR. Current solutions of methane pyrolysis use a natural gas feed for combustion to provide heat to a high temperature pyrolysis process. One issue with using natural gas as a heating source is the resulting CO₂ production, which requires carbon capture to lower the CO₂ emissions.

Another current solution uses a hydrogen gas feed (pulled from the hydrogen produced via pyrolysis) to combust and provide heat to a high temperature pyrolysis process. However, one issue with recirculating hydrogen from the product is a decrease in process efficiency and potential other emissions from combustion of hydrogen.

Thus, there is a need for improved methane pyrolysis processes and systems.

### SUMMARY OF THE INVENTION

Embodiments of the current invention address one or more of the above-mentioned problems and provide a distinct advance in the art of hydrogen and ammonia production, and particularly in production via regulated pyrolysis of a hydrocarbon feed, such as natural gas or methane. The current invention provides systems and methods that reduce the CO₂ emissions by relying on intermittent renewable energy sources to provide electrical energy which is converted to thermal energy that is used during a pyrolysis process to break down the hydrocarbon into separable carbon and hydrogen gas constituents. The systems and methods also utilize a thermal battery to ensure that the energy used during the pyrolysis process is consistent – given that the renewable energy sources may be inconsistent. Furthermore, the systems and methods recirculate hydrocarbons that were not broken down during the pyrolysis process in order to minimize undesirable hydrocarbon emissions and increase efficiency.

An embodiment of the current invention provides a system for producing hydrogen gas from a hydrocarbon feed. The system broadly comprises an intermittent energy source, a thermal battery, and a pyrolysis system. The intermittent energy source is configured to output electrical energy. The thermal battery is in electrical communication with the intermittent energy source and is configured to receive the electrical energy and output a heated fluid thermal storage medium. The pyrolysis system is in flow communication with the thermal battery and is configured to receive the hydrocarbon feed, receive the heated fluid thermal storage medium, heat the hydrocarbon feed, pyrolyze the heated hydrocarbon feed to produce heated pyrolysis products, cool the heated pyrolysis products to produce cooled pyrolysis products, separate carbon black from the cooled pyrolysis products, separate hydrogen gas from a remainder of the cooled pyrolysis products, and output the hydrogen gas.

Another embodiment of the current invention provides a system for producing hydrogen gas from a hydrocarbon feed. The system broadly comprises an intermittent energy source, a thermal battery, and a pyrolysis system. The intermittent energy source is configured to output electrical energy. The thermal battery is in electrical communication with the intermittent energy source and includes a heater, a solid state thermal storage medium, and fluid thermal storage medium. The heater is configured to convert the electrical energy into thermal energy. The solid state thermal storage medium is configured to receive the first thermal energy from the heater. The fluid thermal storage medium is configured to receive thermal energy from the solid state thermal storage medium and produce a heated fluid thermal storage medium. The pyrolysis system is in flow communication with the thermal battery and includes a heat exchanger, a pyrolysis feed/effluent exchanger, a pyrolysis reactor, and a purification system. The heat exchanger is configured to receive the hydrocarbon feed and thermal energy and output a partially preheated hydrocarbon feed and a cooled fluid thermal storage medium. The pyrolysis feed/effluent exchanger is configured to receive the partially preheated hydrocarbon feed and heated pyrolysis products and output a preheated hydrocarbon feed and cooled pyrolysis products. The pyrolysis reactor is configured to receive the preheated hydrocarbon feed and a heated fluid thermal storage medium and output the heated pyrolysis products and a partially cooled fluid thermal medium. The purification system is configured to receive the cooled pyrolysis products and output the carbon black and the hydrogen gas.

Yet another embodiment of the current invention provides a method for producing hydrogen gas from a hydrocarbon feed. The method broadly comprises receiving electrical energy; converting the electrical energy into thermal energy to heat a thermal storage medium to produce a heated thermal storage medium; heating a hydrocarbon feed using output from a pyrolysis reactor to produce a heated hydrocarbon feed; pyrolyze the heated hydrocarbon feed to produce heated pyrolysis products using thermal energy from the heated thermal storage medium; cooling the heated pyrolysis products to produce cooled pyrolysis products; separating carbon black from the cooled pyrolysis products; and separating hydrogen gas from a remainder of the cooled pyrolysis products.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a schematic illustration of a system for producing hydrogen from a hydrocarbon feed and optionally producing another product in a hydrogen consuming process according to an embodiment of the current invention; and

FIG. 2 is a flowchart depicting exemplary steps of a method according to an embodiment of the current invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

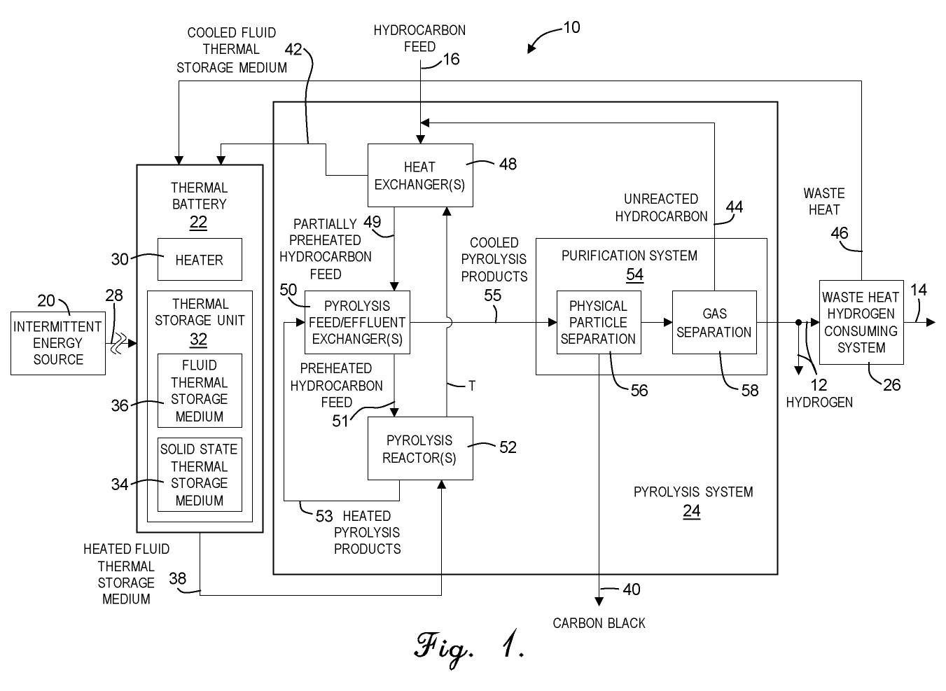

Methane pyrolysis generally has a much lower carbon intensity than steam methane reforming. FIG. 1 schematically depicts a system 10 for producing hydrogen 12 using pyrolysis, such as methane pyrolysis, according to embodiments of the present invention. The system 10 receives one or more hydrocarbon feeds 16, such as natural gas or methane. In one or more embodiments, the system 10 comprises one or more intermittent energy sources 20, one or more thermal batteries 22, and a pyrolysis system 24.

The intermittent energy source 20 may include any renewable energy source which is intermittent, i.e., non-continuous, in generating energy, including one or more solar panels, one or more wind turbines, one or more concentrated solar power panels such as panels which include mirrors and/or lenses configured to reflect and/or focus infrared solar energy onto a receiver, or the like, or combinations thereof. The intermittent energy source 20 is configured to generate or output electricity or electrical energy, i.e., a product of electric voltage and electric current generated for a period of time. The intermittent energy source 20 may be on-site with the rest of the system 10 or at an off-site location, as indicated by the break lines on one or more conduits 28 in communication with the intermittent energy source 20 and the thermal battery 22. The conduits 28 may include one or more electrical conductor(s) for transmitting electricity, i.e., conducting electric voltage and/or electric current.

The thermal battery 22 receives electrical energy from the intermittent energy source 20 and stores it in the form of thermal energy. The thermal battery 22 may include any device or system operable to store thermal energy. An exemplary thermal battery 22 may include the Rondo Heat Battery made by Rondo Energy, Inc., the energy storage device disclosed and described in U.S. Patent No. 10,550,765, which are hereby incorporated by reference herein, or the like. The thermal battery 22 solves the intermittency issue of renewable energy sources 20 while also not needing combustion or the use of natural gas/hydrogen feed 16 for combustion. This increases the yield of the process and decreases the carbon intensity of the process.

In one or more embodiments, the thermal battery 22 also includes one or more heaters 30 and one or more thermal storage units 32. The heater 30 is configured to direct the energy to be thermally stored in the one or more thermal storage mediums stored in the thermal storage unit 32. In preferred embodiments, the heater 30 is configured to convert electrical energy into thermal energy and heat the thermal storage medium. The heater 30 comprises an infrared heater configured to heat a solid thermal storage medium (as discussed below) for storage of the thermal energy. An exemplary heater 30 may include one or more resistive electrical conductors through which electrical current flows and is converted to heat.

The thermal storage unit 32 is configured to hold the thermal storage medium(s) and may include a plurality of tanks and other storage containers in which the media are stored or held. The thermal storage medium may be any type of material in any state – gas, liquid, solid, etc. – that is operable to store thermal energy. The thermal storage medium includes a solid state thermal storage medium 34 and a fluid thermal storage medium 36, such as liquid or gas. The heater 30 is typically positioned in proximity to, or in contact with, the solid state thermal storage medium 34 in order to heat it. The fluid thermal storage medium 36 absorbs the heat from solid state thermal storage medium 34 and transports the thermal energy. The thermal storage medium comprises a material that is operable to reach temperatures of approximately 1,000 degrees Celsius, and in preferred embodiments, the thermal storage medium comprises a material that is operable to reach temperatures of approximately 1,500 degrees Celsius. Exemplary embodiments of the solid state thermal storage medium 34 include solid components formed from materials having thermal storage or capacity properties – materials such as ceramic, porcelain, graphite, and the like. Exemplary embodiments of the fluid thermal storage medium 36 include gases such as air, nitrogen, other inert gas, etc. The fluid thermal storage medium 36 is heated to produce a heated fluid thermal storage medium 38, which is communicated to the pyrolysis system 24 for pyrolyzing the hydrocarbon feed 16.

The pyrolysis system 24 is configured to pyrolyze the hydrocarbon feed using the thermal energy provided by the thermal battery 22. The pyrolysis system 24 is in flow communication with the hydrocarbon feed 16 and the thermal battery 22 to use the thermal energy stored in the heated fluid thermal storage medium 38 to split the hydrocarbon feed 16 to produce carbon black 40, hydrogen 12, and a cooled fluid medium 42. The pyrolysis system 24 includes one or more exchangers for allowing the hydrocarbon feed 16 and the heated fluid thermal storage medium 38 to be thermally coupled while prohibiting mixing of the hydrocarbon feed 16 and the heated fluid thermal storage medium 38. At least a portion of the cooled fluid medium 42 is then supplied back to the thermal battery 22 for reheating. By recycling the cooled fluid medium 42 from the pyrolysis system 24 back into the thermal battery 22, at least a portion of the thermal energy is preserved, thereby increasing the efficiency of the system 10 and process.

In one or more embodiments, the pyrolysis system 24 includes one or more heat exchanger(s) 48, one or more pyrolysis feed or effluent exchanger(s) 50, one or more pyrolysis reactor(s) 52, and a purification system 54. The heat exchanger 48 is configured to receive the hydrocarbon feed 16 (and in one or more embodiments, an unreacted hydrocarbon recycle feed 44) and partially preheat the hydrocarbon. The heat exchanger 48 uses residual thermal energy T from the heated fluid thermal storage medium 38 downstream from the pyrolysis reactor 52 in a thermal exchange process to partially preheat the hydrocarbon feed 16. As a result of the thermal exchange process between the thermal energy T (which is relatively higher in temperature) and the hydrocarbon feed 16 (which is relatively lower in temperature), the heat exchanger 48 outputs a cooled fluid medium 42 which is received by the thermal battery 22 for reheating.

The pyrolysis feed/effluent exchanger 50 receives the partially preheated hydrocarbon feed 49 as a first input and heated pyrolysis products 53 from the pyrolysis reactor 52 as a second input. In one or more embodiments, the pyrolysis feed/effluent exchanger 50 is configured to use the high thermal energy of the heated pyrolysis products 53 in a thermal exchange process to preheat or further heat the partially preheated hydrocarbon feed 49 to produce a preheated hydrocarbon feed 51 as a first output. As a result of the thermal exchange between the heated pyrolysis products 53 (which is relatively higher in temperature) and the partially preheated hydrocarbon feed 49 (which is relatively lower in temperature), the pyrolysis feed/effluent exchanger 50 cools the heated pyrolysis products 53 to produce cooled pyrolysis products 55 as a second output.

The pyrolysis reactor 52 receives the preheated hydrocarbon feed 51 from the pyrolysis feed/effluent exchanger 50 as a first input and the heated fluid thermal storage medium 38 as a second input. The pyrolysis reactor 52 is configured to use the heated fluid thermal storage medium 38 to pyrolyze the preheated hydrocarbon feed 51 at a temperature of approximately 1,000 degrees Celsius to produce the heated pyrolysis products 53 as a first output. As an example, if the preheated hydrocarbon feed 51 includes methane, then the heated pyrolysis products 53 may include some methane which did not undergo a pyrolysis reaction (CH₄ → C + 2H₂) as well as carbon and hydrogen gas, which did undergo the pyrolysis reaction. As discussed previously, the pyrolysis reactor 52 is configured to thermally couple the preheated hydrocarbon feed 51 while prohibiting it from mixing with the heated fluid thermal storage medium 38 to avoid combustion. The pyrolysis reactor 52 also produces residual thermal energy T as a second output which is received by the heat exchanger 48. The residual thermal energy T may be a property of a partially cooled fluid thermal storage medium output by the pyrolysis reactor 52.

By thermally integrating the heated fluid thermal storage medium 38 and the preheated hydrocarbon feed 51, the thermal energy of the system is internally recuperated, thereby maximizing the heat provided to the process. This improves the efficiency of the system 10.

The purification system 54 receives the cooled pyrolysis products 55, which may include hydrogen gas, carbon particulates, and unreacted hydrocarbon feed. The purification system 54 comprises a physical particle separation system 56 and a gas separation system 58. The physical particle separation system 56 is configured to separate the carbon particulates from the other cooled pyrolysis products 55 and output carbon black 40 as a first output and the remaining cooled pyrolysis products 55 as a second output. The physical particle separation system 56 may comprise a cyclone, filter, or the like. The gas separation system 58 receives the remaining cooled pyrolysis products 55 and is configured to separate the remaining products and output unreacted hydrocarbon 44 and the hydrogen 12. In one or more embodiments, the unreacted hydrocarbon 44 is recycled back to the heat exchanger 48 where it is an input and/or is mixed with the hydrocarbon feed 16. The hydrogen 12 is output from the system 10 and may be transported or communicated to other locations for consumption such as providing the hydrogen in a fuel cell electric vehicle.

In one or more embodiments, the system 10 may also be connected to one or more hydrogen consuming systems 26 for outputting a product 14, wherein at least a portion of the hydrogen 12 output by the system 10 is input to the system 26. The hydrogen consuming system 26 may be a Haber Bosch system for synthesizing ammonia, as an example of the product 14, from the hydrogen 12 produced by the pyrolysis system 24 and a nitrogen feed, a Fischer Tropsch system for synthesizing methanol, or the like. The hydrogen consuming system 26 may implement an exothermic process. The hydrogen consuming system 26 may be any hydrogen consuming system without departing from the scope of the present invention, such as the ammonia reactor described in U.S. Patent No. 10,131,545, which is hereby incorporated by reference herein. The hydrogen consuming system 26 generates waste heat 46, which may be communicated to and stored in the thermal battery 22, thereby increasing the efficiency of the system 10.

As an example of the operation of the system 10, the intermittent energy source 20 may generate approximately 5.2 MWh(e) of energy and the thermal battery 22 may output approximately 5.1 MWh(th) of energy. The hydrocarbon feed 16 may include approximately 4,000 kg of methane. The pyrolysis system 24 may output approximately 3,000 kg of solid carbon and approximately 1,000 kg of hydrogen gas.

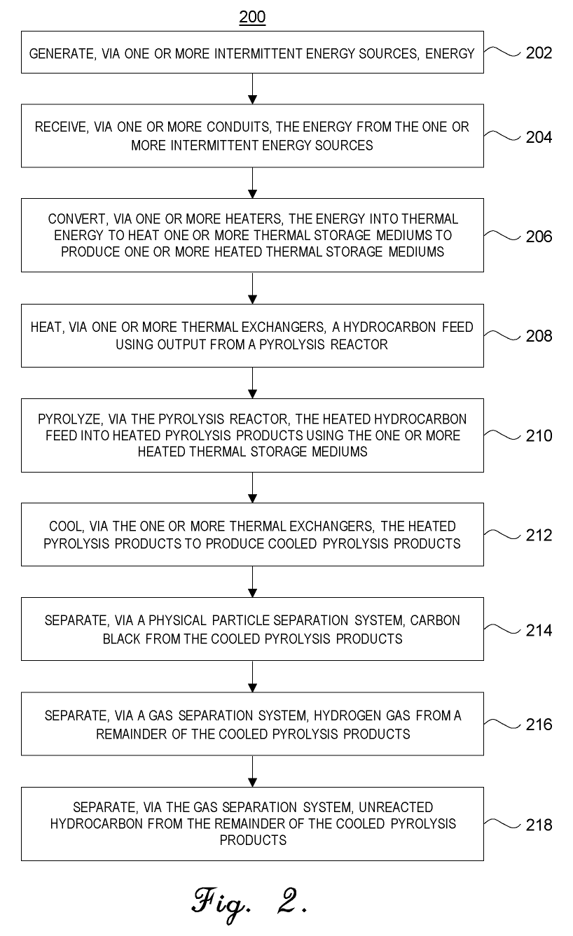

The flow chart of FIG. 2 depicts the steps of an exemplary method 200 of forming hydrogen. In some alternative implementations, the functions noted in the various blocks may occur out of the order depicted in FIG. 2. For example, two blocks shown in succession in FIG. 2 may in fact be executed substantially concurrently, or the blocks may sometimes be executed in the reverse order depending upon the functionality involved. In addition, some steps may be optional. The method 200 is described below may be executed by the exemplary devices and components introduced with the embodiment illustrated in FIG. 1.

Referring to step 202, energy is captured and/or generated via one or more intermittent i.e., non-continuous, energy sources 20. The intermittent energy source 20 may include any renewable energy source, including one or more solar panels, one or more wind turbines, one or more concentrated solar power panels, or the like, or combinations thereof. The energy may be generated on-site with the rest of the system or at an off-site location. In preferred embodiments, the energy comprises electricity or electrical energy, i.e., a product of electric voltage and electric current generated for a period of time.

Referring to step 204, the energy is received, via one or more conduits 28, from the intermittent energy source 20. As discussed above, the conduits 28 may include an electrical conductor for transmitting the electricity, i.e., conducting electric voltage and/or electric current.

Referring to step 206, the energy is converted, via one or more heaters 30, into thermal energy and stored in one or more thermal energy storage units 32. In one or more embodiments, the heater 30 converts the energy into thermal energy by heating one or more thermal storage mediums stored in one or more thermal energy storage units 32. The thermal storage medium may be any type of material in any state—gas, liquid, solid, etc.—that is operable to store thermal energy. In one or more embodiments, the thermal storage medium includes a solid state thermal storage medium 34 and a fluid thermal storage medium 36, such as liquid or gas. In one or more embodiments, this step includes heating, via the heater 30, the solid state thermal storage medium 34, and transferring the heat to the fluid thermal storage medium 36, which absorbs the heat from solid state thermal storage medium 34 for communicating the thermal energy. In one or more embodiment, the thermal storage medium comprises a material that is operable to reach approximately 1,000 degrees Celsius, and in preferred embodiments, the thermal storage medium comprises a material that is operable to reach approximately 1,500 degrees Celsius. In one or more embodiments, the heated thermal storage medium is communicated to a pyrolysis system 24 for pyrolyzing the hydrocarbon feed 16. As discussed herein, in one or more embodiments, this step may include receiving heat produced by a hydrogen consuming system for storing in the thermal battery 22. By using the thermal battery 22, hydrogen can be continuously produced in spite of the fluctuations of energy provided by the intermittent energy source 20.

The thermal battery 22 receives electrical energy from the intermittent energy source 20 and stores it in the form of thermal energy. The thermal battery 22 may include any device or system operable to store thermal energy. An exemplary thermal battery 22 may include the Rondo Heat Battery made by Rondo Energy, Inc., the energy storage device disclosed and described in U.S. Patent No. 10,550,765, which are hereby incorporated by reference herein, or the like.

The thermal battery 22 also includes one or more heaters 30 and one or more thermal storage units 32. The heater 30 is configured to direct the energy to be thermally stored in the one or more thermal storage mediums stored in the thermal storage unit 32. In preferred embodiments, the heater 30 is configured to convert electrical energy into thermal energy and heat the thermal storage medium. The heater 30 comprises an infrared heater configured to heat a solid thermal storage medium (as discussed below) for storage of the thermal energy. An exemplary heater 30 may include one or more resistive electrical conductors through which electrical current flows and is converted to heat.

The thermal storage unit 32 is configured to hold the thermal storage medium(s) and may include a plurality of tanks and other storage containers in which the media are stored or held. The thermal storage medium may be any type of material in any state – gas, liquid, solid, etc. – that is operable to store thermal energy. The thermal storage medium includes a solid state thermal storage medium 34 and a fluid thermal storage medium 36, such as liquid or gas. The heater 30 is typically positioned in proximity to, or in contact with, the solid state thermal storage medium 34 in order to heat it. The fluid thermal storage medium 36 absorbs the heat from solid state thermal storage medium 34 and transports the thermal energy. The thermal storage medium comprises a material that is operable to reach approximately 1,000 degrees Celsius, and in preferred embodiments, the thermal storage medium comprises a material that is operable to reach approximately 1,500 degrees Celsius. Exemplary embodiments of the solid state thermal storage medium 34 include solid components formed from materials having thermal storage or capacity properties – materials such as ceramic, porcelain, graphite, and the like. Exemplary embodiments of the fluid thermal storage medium 36 include gases such as air, nitrogen, other inert gas, etc. The fluid thermal storage medium 36 is heated to produce a heated fluid thermal storage medium 38, which is communicated to the pyrolysis system 24 for pyrolyzing the hydrocarbon feed 16.

Referring to step 208, the hydrocarbon feed is heated, or preheated, via one or more thermal exchangers using output from a pyrolysis reactor, wherein the thermal exchangers include one or more heat exchangers 48 and one or more pyrolysis feed/effluent exchangers 50. In one or more embodiments, this step includes partially preheating the hydrocarbon feed 16 via the heat exchanger 48 using thermal storage medium cascaded down from one or more pyrolysis reactor(s) 52. This step may further include partially preheating unreacted hydrocarbon from a purification system 54. This step may include directing a cooled fluid thermal storage medium 42 back to the thermal battery 22 for reheating. This step may further include preheating, via a pyrolysis feed/effluent exchanger 50, the partially preheated hydrocarbon feed 49 using the heated pyrolysis products 53. In one or more embodiments, this step further includes preheating, via the pyrolysis feed/effluent exchanger 50, the partially preheated hydrocarbon feed 49 using the heated pyrolysis products 53 from the pyrolysis reactor 52 to produce a preheated hydrocarbon feed 51. This step may include directing the preheated hydrocarbon feed 51 to the pyrolysis reactor 52.

In one or more embodiments, the pyrolysis system 24 includes one or more heat exchanger(s) 48 and one or more pyrolysis feed or effluent exchanger(s) 50. The heat exchanger 48 is configured to receive the hydrocarbon feed 16 (and in one or more embodiments, an unreacted hydrocarbon recycle feed 44) and partially preheat the hydrocarbon. The heat exchanger 48 uses residual thermal energy T from the heated fluid thermal storage medium 38 downstream from the pyrolysis reactor 52 in a thermal exchange process to partially preheat the hydrocarbon feed 16. As a result of the thermal exchange process between the thermal energy T (which is relatively higher in temperature) and the hydrocarbon feed 16 (which is relatively lower in temperature), the heat exchanger 48 outputs a cooled fluid medium 42 which is received by the thermal battery 22 for reheating.

The pyrolysis feed/effluent exchanger 50 receives the partially preheated hydrocarbon feed 49 as a first input and heated pyrolysis products 53 from the pyrolysis reactor 52 as a second input. The pyrolysis feed/effluent exchanger 50 is configured to use the high thermal energy of the heated pyrolysis products 53 in a thermal exchange process to preheat or further heat the partially preheated hydrocarbon feed 49 to produce a preheated hydrocarbon feed 51 as a first output.

Referring to step 210, the preheated hydrocarbon feed 51 is pyrolyzed via one or more pyrolysis reactors 52. The pyrolysis reactor 52 is configured to pyrolyze the preheated hydrocarbon feed using the thermal energy, i.e., the heated fluid thermal storage medium 38, provided by the thermal storage unit 32. The pyrolysis reactor 52 is in flow communication with the pyrolysis feed/effluent exchange 50 to receive the preheated hydrocarbon feed 51 and the thermal storage unit 32 to receive the heated fluid thermal storage medium 38 to split the preheated hydrocarbon feed 51 to produce heated pyrolysis products 53 and residual thermal energy T.

The pyrolysis reactor 52 receives the preheated hydrocarbon feed 51 from the pyrolysis feed/effluent exchanger 50 as a first input and the heated fluid thermal storage medium 38 as a second input. The pyrolysis reactor 52 is configured to use the heated fluid thermal storage medium 38 to pyrolyze the preheated hydrocarbon feed 51 at a temperature of approximately 1,000 degrees Celsius to produce the heated pyrolysis products 53 as a first output. As an example, if the preheated hydrocarbon feed 51 includes methane, then the heated pyrolysis products 53 may include some methane which did not undergo a pyrolysis reaction (CH₄ → C + 2H₂) as well as carbon and hydrogen gas, which did undergo the pyrolysis reaction. As discussed previously, the pyrolysis reactor 52 is configured to thermally couple the preheated hydrocarbon feed 51 while prohibiting it from mixing with the heated fluid thermal storage medium 38. The pyrolysis reactor 52 also produces residual thermal energy T as a second output which is received by the heat exchanger 48.

Referring to step 212, the heated pyrolysis products 53 are cooled to produce cooled pyrolysis products 55. As a result of the thermal exchange between the heated pyrolysis products 53 (which is relatively higher in temperature) and the partially preheated hydrocarbon feed 49 (which is relatively lower in temperature), the pyrolysis feed/effluent exchange 50 cools the heated pyrolysis products 53 to produce cooled pyrolysis products 55 as a second output.

Referring to step 214, carbon black 40 is separated from the cooled pyrolysis products 55 using a physical particle separation system 56. A purification system 54 receives the cooled pyrolysis products 55, which may include hydrogen gas, carbon particulates, and unreacted hydrocarbon feed. The purification system 54 comprises a physical particle separation system 56. The physical particle separation system 56 is configured to separate the carbon particulates from the other cooled pyrolysis products 55 and output carbon black 40 as a first output and the remaining cooled pyrolysis products 55 as a second output. The physical particle separation system 56 may comprise a cyclone, filter, or the like.

Referring to step 216, hydrogen gas 12 is separated from a remainder of the cooled pyrolysis products 55 using a gas separation system 58. The purification system 54 further comprises the gas separation system 58. The gas separation system 58 receives the remaining cooled pyrolysis products 55 and is configured to separate the remaining products and output the hydrogen 12.

Referring to step 218, the unreacted hydrocarbon 44 is separated from the remainder of the cooled pyrolysis products 55 using the gas separation system 58. The gas separation system 58 receives the remaining cooled pyrolysis products 55 and is configured to separate the remaining products and output the unreacted hydrocarbon 44. The unreacted hydrocarbon 44 is recycled back to the heat exchanger 48 where it is an input and/or is mixed with the hydrocarbon feed 16.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A system for producing hydrogen gas from a hydrocarbon feed, the system comprising:
an intermittent energy source configured to output electrical energy;
a thermal battery in electrical communication with the intermittent energy source, the thermal battery configured to receive the electrical energy and output a heated fluid thermal storage medium;
a pyrolysis system in flow communication with the thermal battery, the pyrolysis system configured to
receive the hydrocarbon feed,
receive the heated fluid thermal storage medium,
heat the hydrocarbon feed,
pyrolyze the heated hydrocarbon feed to produce heated pyrolysis products,
cool the heated pyrolysis products to produce cooled pyrolysis products,
separate carbon black from the cooled pyrolysis products,
separate hydrogen gas from a remainder of the cooled pyrolysis products, and
output the hydrogen gas.

2. The system of claim 1, wherein the intermittent energy source is selected from renewable energy sources including at least one of a solar panel, a concentrated solar power panel, and a wind turbine.

3. The system of claim 1, wherein the thermal battery includes
a heater configured to convert the electrical energy into a first thermal energy,
a solid state thermal storage medium configured to receive the first thermal energy from the heater, and
a fluid thermal storage medium configured to receive a second thermal energy from the solid state thermal storage medium and produce a heated fluid thermal storage medium.

4. The system of claim 3, wherein the solid state thermal storage medium includes solid components formed from materials selected from the group consisting of ceramic, porcelain, and graphite.

5. The system of claim 3, wherein the fluid thermal storage medium includes nitrogen gas.

6. The system of claim 1, wherein the pyrolysis system includes
a heat exchanger configured to receive the hydrocarbon feed and a third thermal energy and output a partially preheated hydrocarbon feed and a cooled fluid thermal storage medium,
a pyrolysis feed/effluent exchanger configured to receive the partially preheated hydrocarbon feed and heated pyrolysis products and output a preheated hydrocarbon feed and cooled pyrolysis products,
a pyrolysis reactor configured to receive the preheated hydrocarbon feed and a heated fluid thermal storage medium and output the heated pyrolysis products and the third thermal energy, and
a purification system configured to receive the cooled pyrolysis products and output the carbon black and the hydrogen gas.

7. The system of claim 6, wherein the purification system includes
a physical particle separation system configured to separate the carbon black from the cooled pyrolysis products, and
a gas separation system configured to separate the remainder of the cooled pyrolysis products into the hydrogen gas and unreacted hydrocarbon feed.

8. A system for producing hydrogen gas from a hydrocarbon feed, the system comprising:
an intermittent energy source configured to output electrical energy;
a thermal battery in electrical communication with the intermittent energy source, the thermal battery including
a heater configured to convert the electrical energy into a first thermal energy,
a solid state thermal storage medium configured to receive the first thermal energy from the heater, and
a fluid thermal storage medium configured to receive a second thermal energy from the solid state thermal storage medium and produce a heated fluid thermal storage medium;
a pyrolysis system in flow communication with the thermal battery, the pyrolysis system including
a heat exchanger configured to receive the hydrocarbon feed and a third thermal energy and output a partially preheated hydrocarbon feed and a cooled fluid thermal storage medium,
a pyrolysis feed/effluent exchanger configured to receive the partially preheated hydrocarbon feed and heated pyrolysis products and output a preheated hydrocarbon feed and cooled pyrolysis products,
a pyrolysis reactor configured to receive the preheated hydrocarbon feed and a heated fluid thermal storage medium and output the heated pyrolysis products and the third thermal energy, and
a purification system configured to receive the cooled pyrolysis products and output the carbon black and the hydrogen gas.

9. The system of claim 8, wherein the intermittent energy source is selected from renewable energy sources including at least one of a solar panel, a concentrated solar power panel, and a wind turbine.

10. The system of claim 8, wherein the solid state thermal storage medium includes solid components formed from materials selected from the group consisting of ceramic, porcelain, and graphite.

11. The system of claim 8, wherein the fluid thermal storage medium includes nitrogen gas.

12. The system of claim 8, wherein the purification system includes
a physical particle separation system configured to separate the carbon black from the cooled pyrolysis products, and
a gas separation system configured to separate the remainder of the cooled pyrolysis products into the hydrogen gas and unreacted hydrocarbon feed.

13. A method for producing hydrogen gas from a hydrocarbon feed, the method comprising:
receiving electrical energy;
converting the electrical energy into thermal energy to heat a thermal storage medium to produce a heated thermal storage medium;
heating a hydrocarbon feed using output from a pyrolysis reactor to produce a heated hydrocarbon feed;
pyrolyze the heated hydrocarbon feed to produce heated pyrolysis products using the heated thermal storage medium;
cooling the heated pyrolysis products to produce cooled pyrolysis products;
separating carbon black from the cooled pyrolysis products; and
separating hydrogen gas from a remainder of the cooled pyrolysis products.

14. The method of claim 13, wherein the electrical energy is received from an intermittent energy source.

15. The method of claim 13, wherein the electrical energy is converted into thermal energy by a thermal battery including
a heater configured to convert the electrical energy into a first thermal energy,
a solid state thermal storage medium configured to receive the first thermal energy from the heater, and
a fluid thermal storage medium configured to receive a second thermal energy from the solid state thermal storage medium and produce the heated thermal storage medium.

16. The method of claim 13, wherein the hydrocarbon feed is heated by
a heat exchanger configured to receive the hydrocarbon feed and a third thermal energy and output a partially preheated hydrocarbon feed and a cooled fluid thermal storage medium, and
a pyrolysis feed/effluent exchanger configured to receive the partially preheated hydrocarbon feed and heated pyrolysis products and output the heated hydrocarbon feed and cooled pyrolysis products.

17. The method of claim 16, wherein the heated hydrocarbon is pyrolyzed by the pyrolysis reactor configured to receive the heated hydrocarbon feed and the heated thermal storage medium and output the heated pyrolysis products and the third thermal energy.

18. The method of claim 16, wherein the heated pyrolysis products are cooled by the pyrolysis feed/effluent exchanger.

19. The method of claim 13, wherein the carbon black is separated from the cooled pyrolysis products by a physical particle separation system.

20. The method of claim 13, wherein the hydrogen is separated from the remainder of the cooled pyrolysis products by a gas separation system.
